(19) United States
(12) Patent Application Publication
(10) Pub. No.: US 2009/0248234 A1
(43) Pub. Date: Oct. 1, 2009

(54) METHODS AND SYSTEMS FOR CONTROLLING TESTING IN VEHICLES

(75) Inventor: Lanny Fields, Peoria, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 12/054,629

(22) Filed: Mar. 25, 2008

(51) Int. Cl. G01M 17/00

(52) U.S. Cl. 701/31

(57) ABSTRACT

A method for controlling testing in a vehicle includes the steps of receiving a request for execution of a test pertaining to the vehicle, determining whether the vehicle is in a predetermined state, and transmitting a signal to fulfill the request if the vehicle is in the predetermined state.

### TECHNICAL FIELD

The present invention generally relates to vehicles, and, more particularly, to improved methods, program products, and systems for controlling testing in vehicles.

### BACKGROUND

Maintenance activities and testing are central to the use and operation of vehicles, such as airplanes. Modern airplanes are increasingly becoming more computerized and more integrated. As a result, maintenance and testing systems and techniques have been increasing in complexity as well.

Typically, a flight control computer or another electronic device is used for administering an entire suite of tests for not only itself, but also for the other non-computational units that it interfaces with and perhaps some with limited computational ability. In addition, units which have limited or no computational capability are usually not designed with a self-test capability, or their self-test capability might be limited to their own unit. However, this may be less than ideal in certain circumstances, for example when a quick troubleshooting is desired for a group of units on an airplane which might be experiencing a fault.

For airplanes with a high degree of integrated functionality within a computational unit or host electronic unit, there typically is an even higher degree of complexity associated with the administration of maintenance tests to stimulate the system to produce a response and determine whether the unit under test is functional. During the development of the maintenance test software, this complexity can lead to different architectures of the test software for each individual test and/or to one or more architectures having a less than optimal level of efficiency.

Accordingly, there is a need for an improved method for controlling testing in vehicles, for example with an improved and/or streamlined architecture and/or that allows for quick troubleshooting for a group of units on an airplane and/or with an improved level of efficiency. There is also a need for an improved program product for controlling testing in vehicles, for example with an improved and/or streamlined architecture and/or that allows for quick troubleshooting for a group of units on an airplane and/or with an improved level of efficiency. In addition, there is a need for an improved system for controlling testing in vehicles, for example with an improved and/or streamlined architecture and/or that allows for quick troubleshooting for a group of units on an airplane and/or with an improved level of efficiency.

Furthermore, other desirable features and characteristics of the present invention will become apparent from the subsequent detailed description of the invention and the appended claims, taken in conjunction with the accompanying Appendix and this background of the invention.

### SUMMARY OF THE INVENTION

In accordance with an exemplary embodiment of the present invention, a method for controlling testing in a vehicle is provided. The method comprises the steps of receiving a request for execution of a test pertaining to the vehicle, determining whether the vehicle is in a predetermined state, and transmitting a signal to fulfill the request if the vehicle is in the predetermined state.

In accordance with another exemplary embodiment of the present invention, a program product for performing diagnostics on a system of a vehicle is provided. The program product comprises a program and a computer-readable signal-bearing media. The program is configured to at least facilitate receiving a request for execution of a test pertaining to the vehicle, determining whether the vehicle is in a predetermined state, and transmitting a signal to fulfill the request if the vehicle is in the predetermined state. The computer-readable signal-bearing media bears the program.

In accordance with a further exemplary embodiment of the present invention, a testing system for a vehicle is provided. The testing system comprises a controller comprising a first module, a second module, and a third module. The first module is configured to at least facilitate receiving a request for execution of a test pertaining to the vehicle. The second module is configured to at least facilitate determining whether the vehicle is in a predetermined state. The third module is coupled to the first module and the second module, and is configured to at least facilitate transmitting a signal to fulfill the request if the vehicle is in the predetermined state.

### BRIEF DESCRIPTION OF THE DRAWINGS

The present invention will hereinafter be described in conjunction with the following drawing figures, wherein like numerals denote like elements, and:

FIG. 1 is a functional block diagram of a testing system for a vehicle having a controller and a test execution unit, in accordance with an exemplary embodiment of the present invention;

FIG. 2 is a functional block diagram of a computer system that can be used in connection with the testing system of FIG. 1, in accordance with an exemplary embodiment of the present invention; and

FIG. 3 is a flowchart of a control process for controlling testing in a vehicle, that can be implemented in connection with the testing system of FIG. 1 and/or the computer system of FIG. 2, in accordance with an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

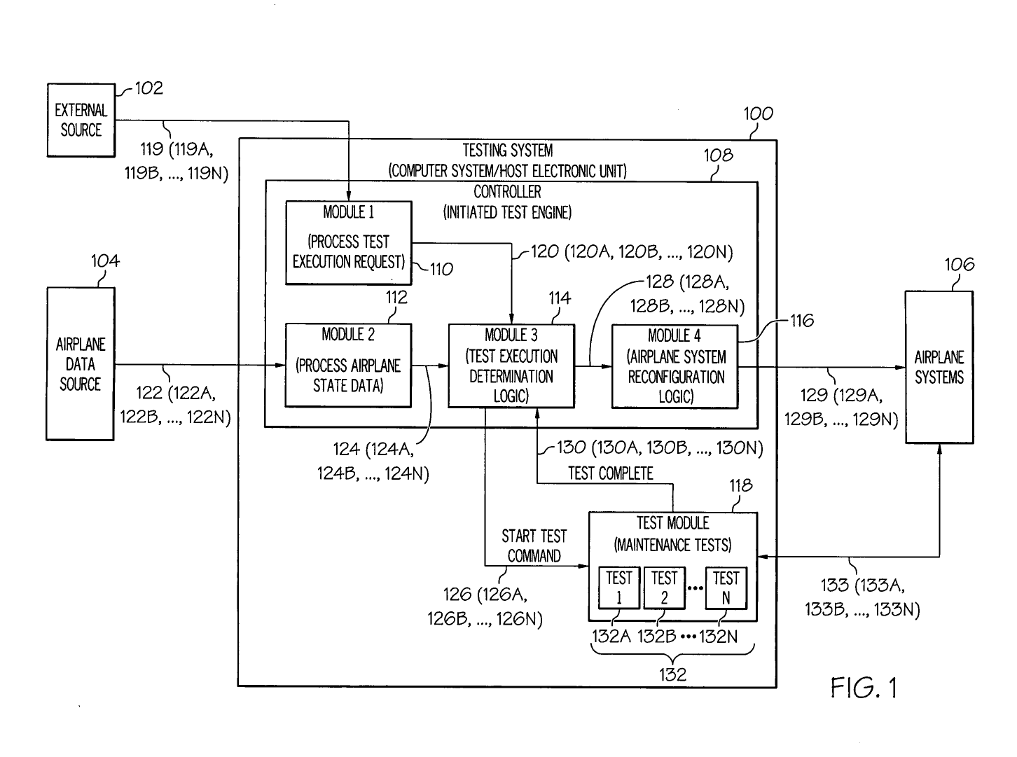

FIG. 1 is a functional block diagram of a testing system 100 for a vehicle, in accordance with an exemplary embodiment of the present invention. The testing system 100 is coupled to an external request source 102, an airplane data source 104, and a plurality of airplane systems 106.

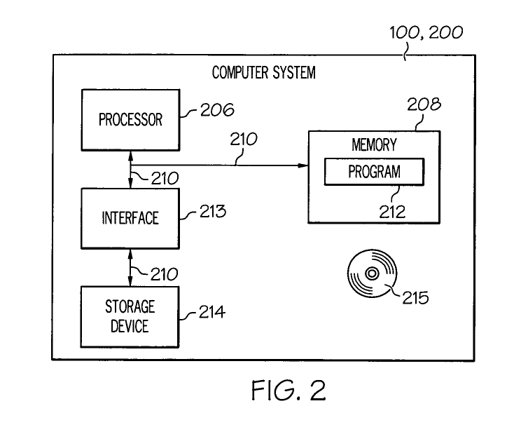

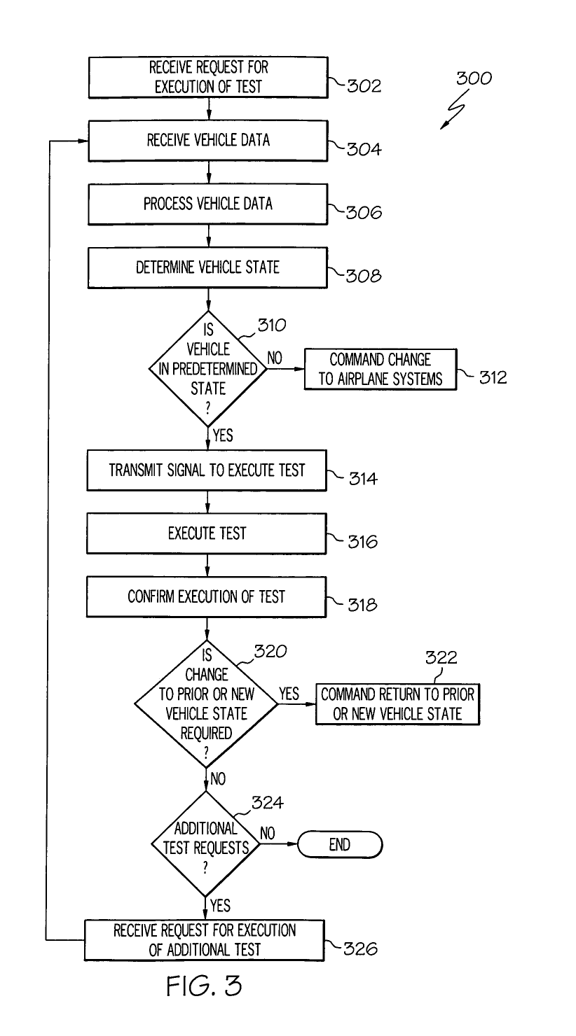

As depicted in FIG. 1, the testing system 100 preferably comprises a computer system and/or a host electronic unit. For example, in one preferred embodiment, the testing system 100 comprises or resides on a flight control computer. In various embodiments the testing system 100 can comprise and/or utilize other devices, instead of or in addition to such as computer system and/or host electronic unit. In addition, while the testing system 100 is depicted in FIG. 1 and described herein as being implemented in connection with an airplane, it will be appreciated that in other embodiments, the testing system 100, along with the exemplary computer system and control process depicted in FIGS. 2 and 3, respectively, and described further below in connection therewith, may instead be implemented in connection with a fleet of airplanes, and/or in connection with one or more other types vehicles and/or other types of devices.

In a preferred embodiment, the external request source 102 comprises a person, machine, or device that is operating, testing, and/or performing maintenance on the airplane. In other preferred embodiments, the external request source 102 comprises a different computer system, electronic unit, module, system, or device, for example within the airplane. In certain embodiments, the external request source 102 also provides a two-way communication interface between the person, machine or device, and the testing system 100.

The airplane data source 104 may also take any one or more of a number of different forms in different embodiments. For example, in one preferred embodiment, the airplane data source 104 comprises one or more sensors, modules, computer systems, and/or other systems or devices within the airplane. In other preferred embodiments, the airplane data source 104 may comprise one or more sensors, modules, computer systems, and/or other systems or devices coupled to or otherwise outside the airplane. In yet other embodiments, the airplane data source 104 may comprise a person, machine, or device that is operating, testing, and/or performing maintenance on the airplane.

The airplane systems 106 utilized in the testing system 100 may similarly take any one or more of a number of different forms in different embodiments. In various embodiments, the airplane systems 106 may include, by way of example only, one or more actuation systems, hydraulic systems, cockpit systems, braking systems, take-off and landing systems, testing systems, and/or any number of other different types of systems.

In the depicted embodiment, the testing system 100 comprises a computer system that comprises a controller 108 and a test module 118. The controller 108 is coupled to the external request source 102, the airplane data source 104, the airplane systems 106, and the test modules 118. As will be described in greater detail below, the controller 108 (i) receives testing requests 119 from the external request source 102 for execution of various requested tests 132; (ii) receives airplane data 122 from the airplane data source 104; (iii) processes the testing requests 119 and the airplane data 122; (iv) issues system adjustment commands 129 for adjustments in the airplane systems 106 as may be appropriate based upon the airplane data 122 and/or the testing requests 119; (v) provides test execution signals 126 to the test module 118 for execution of various requested tests 132 of the test module 118 in accordance with the testing requests 119; (vi) receives test completion signals 130 when the testing is complete; and (vii) provides additional system adjustment commands 129 as may be required for re-adjustments in the airplane systems 106 to a prior state upon execution of the requested tests 132, or to another new state.

In a preferred embodiment, the controller 108 comprises an initiated test engine comprising a first module 110, a second module 112, a third module 114, and a fourth module 116. In a preferred embodiment, each of the first, second, third, and fourth modules 110, 112, 114, and 116 are components of an architecture of the controller 108 of the computer system of the testing system 100. In other embodiments, each of the first, second, third, and fourth modules 110, 112, 114, and 116 represent different algorithms of a program that can be used in connection with a program product and/or the computer system of the testing system 100. In yet other embodiments, the first, second, third, and fourth modules 110, 112, 114, and 116 may each include their own processor and/or computer system, among various other possible embodiments.

The first module 110 is coupled to the external request source 102 and to the third module 114, and at least facilitates receiving and initiating one or more steps for execution of one or more requested tests 132 for the airplane. Specifically, in one preferred embodiment, the first module 110 is configured to receive various testing requests 119 form the external request source 102. In a preferred embodiment, each such testing request 119 pertains to a request for execution of a particular test 132 of the test module 118 pertaining to the airplane. While the testing request 119 is depicted as originating from an external request source 102 in FIG. 1, in other embodiments, the testing request 119 may originate instead from one or more sources internals to the testing system 100.

The first module 110 is further configured to begin processing the testing requests 119, and to provide test request processing signals 120 for each of the testing requests 119 to the third module 114 for further processing, for example as described further below. In a preferred embodiment, the first module 110 receives various such testing requests 119A-119N pertaining to various tests 132A-132N, respectively, of the test module 118, and provides various test request processing signals 120A-120N to the third module 114 for further processing with respect to each of such tests 132A-132N, respectively, of the test module 118.

The second module 112 is coupled to the airplane data source 104 and the third module 114, and at least facilitates receiving airplane data 122 and initiating one or more steps for processing the airplane data 122. Specifically, in a preferred embodiment, the second module 112 is configured to receive airplane data 122 from the airplane data source 104, and is further configured to process the airplane data 122, and to provide the airplane data 122 and/or processing results 124 pertaining thereto to the third module 114 for further processing, for example as described further below. In one preferred embodiment, the airplane data 122 comprises a ground speed of the airplane, one or more on-ground indications, one or more measures of environmental conditions, and/or any one or more of various different types of data. In certain embodiments, different types of airplane data 122A-122N pertain to various tests 132A-132N, respectively, of the test module 118, and the second module 112 provides various processing results 124A-124N to the third module 114 for further processing with respect to each of such tests 132A-132N, respectively, of the test module 118.

The third module 114 is coupled to the first module 110, the second module 112, the fourth module 116, and the test module 118, and at least facilitates initiation of continued processing of the airplane data 122 and issuing of signals for execution of the requested tests 132. Specifically, the third module 114 is configured (i) to receive the test request processing signals 120 from the first module 110; (ii) to further process testing requests 119 pertaining thereto; and (iii) to issue test execution signals 126 to the test module 118 based at least in part thereon. In a preferred embodiment, each test execution signal 126 instructs the test module 118 to execute a particular test 132, based at least in part on one or more test request processing signals 120 received by the third module 114 from the first module 110. In certain other embodiments, when the airplane state data is not correct to allow test execution, a display indication is transmitted to one or more airplane systems to inform an operator that the requested test will not run until the airplane state data is corrected and/or until the operator acknowledges and overrides the incorrect state.

The third module 114 is further configured to receive the processing results 124 from the second module 112, and to provide airplane state and/or test reconfiguration information 128 based at least in part thereon to the fourth module 116 for further processing, for example as described further below. In addition, the third module 114 is further configured to receive test completion signals 130 from the test module 118. Each test completion signal 130 represents the completion of a particular test 132 of the test module pursuant to a corresponding text execution signal 126.

In a preferred embodiment, the third module 114 (i) provides various such test execution signals 126A-126N pertaining to various airplane state information based on different tests 132A-132N, respectively, of the test module 118; (ii) provides various such airplane state and/or test reconfiguration information 128A-128N based on different data required for different tests 132A-132N, respectively, of the test module 118; and (iii) receives various such test completion signals 130A-130N pertaining to various tests 132A-132N, respectively, of the test module 118.

The fourth module 116 is coupled to the third module 114 and the airplane systems 106, and at least facilitates issuing commands for changes to one or more airplane states as may be required prior to execution of one or more requested tests 132 based at least in part from test reconfiguration information 128. Specifically, in a preferred embodiment, the fourth module 116 (i) determines what airplane state(s) are required for execution of a particular test 132 that has been requested; (ii) determines whether or not the airplane is in those particular state(s); (iii) determines whether or not the airplane is required to be transformed back to a prior state or to another new state upon execution of the requested tests 132; and (iv) issues system adjustment commands 129 accordingly.

Each system adjustment command 129 commands one or more of the airplane systems 106 to change to an appropriate vehicle state (e.g., by increasing or decreasing pressure in a hydraulic system, activating or deactivating an actuation system, initiating a self-test capability, and/or making various other changes to a state of the airplane and/or one or more airplane systems 106 thereof) as may be necessary prior to execution of a particular requested test 132, as well as additional adjustment commands that may be necessary to return such one or more airplane systems 106 back to the prior state or to another new state upon execution of the requested test 132. In addition, in a preferred embodiment, the fourth module 116 issues various such system adjustment commands 129A-120N as may be necessary for various different tests 132A-132N, respectively, of the test module 118.

The test module 118 is coupled to the third module 114 and the airplane systems 106. The test module 118 comprises a plurality of tests 132, designated in FIG. 1 and above as tests 132A-N. In a preferred embodiment, each of the tests 132A-N corresponds to a testing of the functioning, maintenance, operability, efficiency, performance, and/or one or more other measures pertaining to one or more of the airplane systems 106 and/or one or more components thereof.

The test module 118 executes the requested tests 132, provides and receives communications 133 as appropriate with the airplane systems 106 in executing the tests 132, and provides test completion signals 130 to the controller 108 upon completion of successful execution of the tests 132. Specifically, in a preferred embodiment, the test module 118 (i) receives the various test execution signals 126A-126N from the third module 114; (ii) executes the corresponding tests 132A-132N in accordance therewith; and (iii) provides the respective test completion signals 130A-130N corresponding thereto upon completion of the respective tests 132A-132N.

An exemplary embodiment of a computer system for the testing system 100 is depicted in FIG. 2, and will be described below in connection therewith. In addition, an exemplary embodiment of a control process executed by the testing system 100 is depicted in FIG. 3, and will also be described further below in connection therewith. It will be appreciated that the testing system 100 and/or various components thereof and/or functions thereof may vary in other embodiments.

FIG. 2 is a functional block diagram of the computer system 200 for a vehicle, in accordance with an exemplary embodiment of the present invention. In one preferred embodiment, the computer system 200 comprises the testing system 100 of FIG. 1. In other preferred embodiments, the computer system 200 stores, implements, or is coupled to the testing system 100 of FIG. 1. In accordance with an exemplary embodiment of the present invention, the computer system 200, and/or one or more programs and/or program products used in connection therewith, can be utilized in implementing a control process described further below in connection with FIG. 3 and other processes and steps described herein.

In the embodiment depicted in FIG. 2, the computer system 200 includes a processor 206, a memory 208, a computer bus 210, an interface 213, and a storage device 214. In certain embodiments, the computer system 200 also provides one or more inputs and outputs to devices, mechanisms or people external to itself. The processor 206 performs the computation and control functions of the testing system 100 and/or components thereof, and may comprise any type of processor or multiple processors, single integrated circuits such as a microprocessor, or any suitable number of integrated circuit devices and/or circuit boards working in cooperation to accomplish the functions of a processing unit. During operation, the processor 206 executes one or more programs 212 preferably stored within the memory 208 and, as such, controls the general operation of the computer system 200. It should be understood that the processor 206 may be a single type of processor, or it may be composed of many different types of processor components.

The memory 208 stores a program or programs 212 that executes one or more embodiments of a control process such as that described further below in connection with FIG. 3, and/or various steps thereof and/or other processes, such as those described elsewhere herein. The memory 208 can be any type of suitable memory. This would include the various types of dynamic random access memory (DRAM) such as SDRAM, the various types of static RAM (SRAM), and the various types of non-volatile memory (PROM, EPROM, and flash). It should be understood that the memory 208 may be a single type of memory component, or it may be composed of many different types of memory components. In addition, the memory 208 and the processor 206 may be distributed across several different computers that collectively comprise the computer system 200. For example, a portion of the memory 208 may reside on a computer within a particular apparatus or process, and another portion may reside on a remote computer.

The computer bus 210 serves to transmit programs, data, status and other information or signals between the various components of the computer system 200. The computer bus 210 can be any suitable physical or logical means of connecting computer systems and components. This includes, but is not limited to, direct hard-wired connections, fiber optics, infrared and wireless bus technologies.

The interface 213 allows communication to the computer system 200, for example from a system operator and/or another computer system, for example to the processor 206, and can be implemented using any suitable method and apparatus. It can include one or more network interfaces to communicate within the testing system 100 of FIG. 1 and/or within or to other systems or components, one or more terminal interfaces to communicate with technicians, and one or more storage interfaces to connect to storage apparatuses such as the storage device 214.

The storage device 214 can be any suitable type of storage apparatus, including direct access storage devices such as hard disk drives, flash systems, floppy disk drives and optical disk drives. In one exemplary embodiment, the storage device 214 is a program product from which memory 208 can receive a program 212 that executes one or more embodiments of a control process of the present invention, and/or steps thereof. In one preferred embodiment, such a program product can be implemented as part of, inserted into, or otherwise coupled to the computer system 200. As shown in FIG. 2, the storage device 214 can comprise a disk drive device that uses disks 215 to store data. As one exemplary implementation, the computer system 200 may also utilize an Internet website, for example for providing or maintaining data or performing operations thereon.

It will be appreciated that while this exemplary embodiment is described in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks (e.g., disk 215), and transmission media such as digital and analog communication links. It will similarly be appreciated that the computer system 200 may also otherwise differ from the embodiment depicted in FIG. 2, for example in that the computer system 200 may be coupled to or may otherwise utilize one or more remote computer systems and/or other control systems.

FIG. 3 is a flowchart of a control process 300 for controlling testing in a vehicle, in accordance with an exemplary embodiment of the present invention. Preferably, the control process 300 can be implemented in connection with the testing system 100 of FIG. 1 and/or the computer system 200 of FIGS. 1 and 2, and/or a program product thereof and/or implemented in connection therewith.

As depicted in FIG. 3, the control process 300 begins with the step of receiving a request for execution of a test for a vehicle (step 302). While the vehicle comprises an airplane in a preferred embodiment, the control process 300 may be implemented in connection with any number of different types of vehicles in various embodiments. In a preferred embodiment, the request comprises one or more testing requests 119 of FIG. 1 for execution of one or more tests 132, and are obtained from the first module 110 from an external request source 102 of FIG. 1. In a preferred embodiment, the one or more requested tests correspond to a testing of the functioning, maintenance, operability, efficiency, performance, and/or one or more other measures pertaining to one or more of the airplane systems 106 of FIG. 1 and/or one or more components thereof. However, this may vary in other embodiments.

In addition, vehicle data is received (step 304). The vehicle data preferably pertains to the particular test requested via the test request received in step 302. Specifically, the vehicle data pertains to one or more states of the vehicle and/or one or more vehicle systems thereof that may be relevant for the execution of the test requested in the test request received in step 302. The vehicle data includes information relevant in determining whether or not the vehicle and/or one or more vehicle systems are in one or more predetermined states that may be required for optimal execution of the requested test.

For example, in one preferred embodiment implemented in connection with an airplane, the vehicle data may comprise a ground speed of the airplane, one or more on-ground indications, one or more measures of environmental conditions, and/or any one or more of various different types of data. In a preferred embodiment, the vehicle data comprises the airplane data 122 of FIG. 1, and pertains to one or more states of the vehicle and/or one or more airplane systems 106 thereof. In addition, preferably the airplane data 122 is obtained by the second module 112 from the airplane data source 104 of FIG. 1. However, this may also vary in other embodiments.

The airplane data 122 is then processed (step 306), and one or more vehicle states are determined based at least in part on the airplane data 122 and/or the processing thereof (step 308). For example, in a preferred embodiment, the airplane data 122 is processed by the second module 110 of FIG. 1, which then provides the airplane data 122 and/or processing results 124 pertaining thereto to the third module 114 of FIG. 1 for further processing, for example as described further below in connection with step 310. However, this may vary in other embodiments.

Next, a determination is made as to whether the vehicle and/or systems thereof are in one or more predetermined states that are required for optimal execution of the requested test (step 310). In a preferred embodiment, this determination is made at least in part by the third module 114, using the airplane data 122 and/or the processing results 124 obtained by the third module 114 from the second module 112 of FIG. 1. However, this may vary depending on the embodiment of the present invention. For example, in certain embodiments, the second module 112, the fourth module 116, and/or one or more other modules, components, and/or devices may also facilitate the determination as to whether or not the vehicle and/or systems thereof are in one or more predetermined states that are required for optimal execution of the requested test.

If it is determined in step 310 that vehicle and/or systems thereof are not in one or more predetermined states that are required for optimal execution of the requested test, then a command is issued to initiate a change in the vehicle state(s), and the vehicle and/or one or more systems thereof are transformed into such one or more predetermined states that are required for optimal execution of the requested test (step 312). For example, this may be accomplished in this step by increasing or decreasing pressure in a hydraulic system, activating or deactivating an actuation system, initiating a self-test capability, and/or making various other changes to a state of the vehicle and/or one or more systems thereof. In certain embodiments, the issued command may direct an operator to perform a reconfiguration of the vehicle and/or systems thereof that are required for optimal execution of the requested test. In the same or other embodiments, the operator may override the command and permit the execution of the requested test.

In a preferred embodiment, this step is performed by the fourth module 116 of FIG. 1. Specifically, in a preferred embodiment, the fourth module 116 issues the system adjustment commands 129 of FIG. 1 to the airplane systems 106 in order to effectuate such required changes in vehicle state(s), based at least in part on the airplane state information and/or test reconfiguration 128 received by the fourth module 116 from the third module 114 of FIG. 1. However, this may vary in other embodiments.

If it is determined in step 310 that vehicle and/or systems thereof are in the one or more predetermined states that are required for optimal execution of the requested test, or once the vehicle and/or systems thereof are transformed into such one or more predetermined states via step 312 as described above, then the process proceeds to step 314. In step 314, a signal to execute the requested test is transmitted. In one preferred embodiment, the signal to execute the requested test comprises the test execution signal 126 of FIG. 1. The test execution signal 126 is preferably generated and transmitted by the third module 114 of FIG. 1 based at least in part on the test request processing signals 120 received by the third module 114 from the first module 110 of FIG. 1, which in turn is based at least in part on the testing request 119 received by the first module 110 from the external request source 102 of FIG. 1. However, this may vary in other embodiments.

Next, the requested test is executed (step 316), and a confirmation is provided upon completion of the successful execution of the requested test (step 318). Also in a preferred embodiment, the test is executed by the test module 118 of FIG. 1, specifically by executing one or more of the tests 132A-132N included therein, based at least in part on the test execution signal 126 provided to the test module 118 from the third module 114. However, this may vary in certain embodiments. For example, in certain embodiments, the third module 114, and/or one or more other modules, systems, and/or devices, may execute the tests 132. The confirmation of the completion of the successful execution of the requested test is preferably provided by the test module 118 of FIG. 1 to the third module 114, and preferably comprises one or more test completion signals 130 such as those described above in connection with FIG. 1. However, this may also vary in other embodiments.

In addition, preferably also after successful completion of execution of the requested test, a determination is made as to whether the vehicle and/or any systems thereof require a change back to a prior state or to another new state (step 320). In a preferred embodiment, this step comprises determining whether a vehicle or system state was changed in step 310 from a prior state to a new state and/or whether a vehicle or system state is required to be in another new state upon successful completion of the test. Also in a preferred embodiment, this determination is made by the third module 114. However, this may vary. For example, in certain embodiments, this determination may be made instead by one or more other modules, systems, and/or devices.

If it is determined in step 320 that the vehicle and/or one or more systems thereof require a change back to a prior state or to another new state, then a command is issued to return the vehicle and/or system(s) thereof to such a prior state or to another new state, and the command is implemented (step 322). For example, in a preferred embodiment, the vehicle and/or system(s) thereof are transformed back to the prior state that existed before any transformations were made in step 312, to the extent that any such transformations were previously made in step 312. In certain other embodiments, the vehicle and/or system(s) thereof are transformed to another new state that did not previously exit before any transformations were made in step 312. For example, this may be accomplished in this step by increasing or decreasing pressure in a hydraulic system, activating or deactivating an actuation system, and/or making various other changes to a state of the vehicle and/or one or more systems thereof.

Also in a preferred embodiment, such transformation back to the prior state(s) or to another new state is accomplished by the fourth module 116 of FIG. 1. Specifically, in a preferred embodiment, the fourth module 116 issues the above-mentioned system adjustment commands 129 of FIG. 1 to the airplane systems 106 in order to effectuate such required transformations back to such prior vehicle state(s) or to another new state. However, this may vary in other embodiments.

If it is determined in step 320 that such a change back to one or more prior vehicle and/or system states or to another new state is not required, or once the vehicle and/or systems thereof are transformed back into such one or more prior states or to another new state in step 322 as described above, then the process proceeds to step 324. In step 324, a determination is made as to whether there are any additional test requests. For example, in a preferred embodiment, in step 324 a determination is made as to whether or not there are any requests for execution of additional tests 132A-132N of the test module 118 of FIG. 1. In certain other embodiments, the determination in step 324 is not performed and instead the process proceeds to a WAIT state wherein it remains until such time when a new request for test execution is received, whereupon the process returns to step 304 and steps 304-326 repeat for execution of the next test.

If a determination is made in step 324 that there are such additional test requests, then the process proceeds to step 326, in which a request is received for execution of such additional tests. The process then returns to step 304, and steps 304-326 repeat for execution of the various requested tests (for example, corresponding to the various tests 132A-132N of FIG. 1) until a determination is made in an iteration of step 324 that there are no additional test requests. In a preferred embodiment, once a determination is made in any iteration of step 324 that there are no such additional test requests, then the process is deemed to be completed, at least until such time as additional test requests are received. In certain other embodiments, once the determination has been made in step 320 to change to a prior or new vehicle state or not, the process proceeds to a WAIT state after any required change in vehicle state, wherein it remains until such time when a new request for test execution is received, whereupon the process returns to step 304 and steps 304-326 repeat for execution of the next test.

It will be appreciated that various steps of the control process 300 may vary. It will similarly be appreciated that various steps of the control process 300 may be performed simultaneously or in a different order than that depicted in FIG. 3 and/or described above in connection therewith. It will also be appreciated that certain steps depicted in FIG. 3 and/or described herein may be combined into a single step in certain embodiments, for example steps 324 and 326.

The testing system 100, the computer system 200, and the control process 300 provide for potentially improved and streamlined testing procedures, for example when quick troubleshooting for a group of units on an airplane is desired and/or with an improved level of efficiency. It will be appreciated that other variations may exist in the testing system 100, the computer system 200, and/or the control process 300. Additionally, it will be appreciated that the testing system 100, the computer system 200, and the control process 300 may be implemented in connection with any number of different types of aircraft, other types of vehicles, systems thereof, components thereof, and/or any number of other different types of devices and/or systems.

Accordingly, an improved method is provided for controlling testing in a vehicle, such as an airplane, is provided. In addition, an improved system is also provided for controlling testing in a vehicle, such as an airplane. An improved program product is further provided for controlling testing in a vehicle, such as an airplane.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A method for controlling testing in a vehicle, the method comprising the steps of:
receiving a request for execution of a test pertaining to the vehicle;
determining whether the vehicle is in a predetermined state; and
transmitting a signal to fulfill the request if the vehicle is in the predetermined state.

2. The method of claim 1, further comprising the step of:
issuing a command to change the vehicle from a prior state to the predetermined state prior to the execution of the test.

3. The method of claim 2, further comprising the step of:
issuing a second command to return the vehicle to the prior state or to another new state after the execution of the test.

4. The method of claim 1, further comprising the steps of:
processing data pertaining to the vehicle; and
determining whether the vehicle is in the predetermined state based at least in part on the processed data.

5. The method of claim 1, further comprising the steps of:
receiving a second request for execution of a second test pertaining to the vehicle;
determining whether the vehicle is in a second predetermined state; and
transmitting a second signal to fulfill the second request if the vehicle is in the second predetermined state.

6. The method of claim 1, wherein the test pertains to maintenance of the vehicle.

7. A program product for controlling testing in a vehicle, the program product comprising:
a program configured to at least facilitate:
receiving a request for execution of a test pertaining to the vehicle;
determining whether the vehicle is in a predetermined state; and
transmitting a signal to fulfill the request if the vehicle is in the predetermined state; and
a computer-readable signal-bearing media bearing the program.

8. The program product of claim 7, wherein the program is further configured to at least facilitate issuing a command to change the vehicle from a prior state to the predetermined state prior to the execution of the test.

9. The program product of claim 8, wherein the program is further configured to at least facilitate issuing a second command to return the vehicle to the prior state or to another new state after the execution of the test.

10. The program product of claim 8, wherein the program is further configured to at least facilitate:
processing data pertaining to the vehicle; and
determining whether the vehicle is in the predetermined state based at least in part on the processed data.

11. The program product of claim 8, wherein the program is further configured to at least facilitate:
receiving a second request for execution of a second test pertaining to the vehicle;
determining whether the vehicle is in a second predetermined state; and
transmitting a second signal to fulfill the second request if the vehicle is in the second predetermined state.

12. A testing system for controlling testing in a vehicle, the testing system comprising a controller comprising:
a first module configured to at least facilitate receiving a request for execution of a test pertaining to the vehicle;
a second module configured to at least facilitate determining whether the vehicle is in a predetermined state; and
a third module coupled to the first and second modules and configured to at least facilitate transmitting a signal to fulfill the request if the vehicle is in the predetermined state.

13. The testing system of claim 12, wherein the controller further comprises:
a fourth module coupled to the second module and configured to at least facilitate issuing a command to change the vehicle from a prior state to the predetermined state prior to the execution of the test.

14. The testing system of claim 13, wherein the fourth module is further configured to at least facilitate issuing a second command to return the vehicle to the prior state or to another new state after the execution of the test.

15. The testing system of claim 12, wherein the test pertains to maintenance of the vehicle.

16. The testing system of claim 12, wherein:
the first module is further configured to at least facilitate receiving a second request for execution of a second test pertaining to the vehicle;
the second module is further configured to at least facilitate determining whether the vehicle is in a second predetermined state; and
the third module is further configured to at least facilitate transmitting a second signal to fulfill the second request if the vehicle is in the second predetermined state.

17. The testing system of claim 16, further comprising:
a test module coupled to the controller and configured to at least facilitate receiving the second signal to fulfill the second request and executing the second test upon receipt of the second signal.

18. The testing system of claim 17 wherein the test module is further configured to at least facilitate receiving the second signal and executing the second test upon receiving the second signal.

19. The testing system of claim 18, wherein the controller further comprises a fourth module coupled to the second module and configured to at least facilitate:
issuing a first command to change the vehicle from a first prior state to the predetermined state prior to the execution of the test; and
issuing a second command to change the vehicle from a second prior state to the second predetermined state prior to the execution of the second test.

20. The testing system of claim 19, wherein the fourth module is further configured to at least facilitate:
issuing a third command to return the vehicle to the first prior state or to another new state after the execution of the test; and
issuing a fourth command to return the vehicle to the second prior state or to another new state after the execution of the second test.
